(19) United States
(12) Patent Application Publication
(10) Pub. No.: US 2009/0033103 A1
(43) Pub. Date: Feb. 5, 2009

(54) Multi-point lock for locking doors or wall parts in housings or cupboards

(76) Inventors: Samuel Klassen, Haiger (DE); Markus Franz, Haiger (DE); Dennis Cappel, Haiger (DE); Sebastian Koch, Wuppertal (DE); Peter Hoeschler, Velbert (DE); Dieter Ramsauer, Schwelm (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/990,548

(22) PCT Filed: Aug. 12, 2006
(86) PCT No.: PCT/EP2006/008003

§ 371 Date: Feb. 27, 2008

(30) Foreign Application Priority Data
Aug. 16, 2005 (DE) 20 2005 012 859.7

(51) Int. Cl. E05C 3/06

(52) U.S. Cl. 292/216

(57) ABSTRACT

A closure for multi-point locking of doors or wall parts in housings or cabinets by a—preferably securable—actuating element such as a handle lever comprises a coupling element which is connected with the actuating element mounted in the door or wall so as to be rigid against rotation relative to it and which transforms a rotational movement into a substantially translational movement and which is coupled with a rod that is mounted near the edge of the door or wall so as to be displaceable, one or more locking elements being coupled with the rod by a coupling element, respectively, in such a way that they move from a locked position into an unlocked position (or vice versa) by the displacement of the rod from a first position into a second position, wherein the locking elements and the coupling elements are formed in each instance by a two-armed, one-piece lever, one of whose lever arms is a locking tongue and whose other lever arm is articulated by its end at the rod. According to the invention, the two lever arms enclose an angle of 120 to 150 angular degrees, preferably approximately 135 (or 225) angular degrees, and at least one of the two-armed levers is connected to the driveshaft of an actuating element so as to be rigid against rotation relative to it.

### CROSS-REFERENCE TO RELATED APPLICATIONS

This is a national phase application of International Application No. PCT/CH2006/008003, filed Aug. 12, 2006 which claims priority of German Application No. 20 2005 012 859.7, filed Aug. 16, 2005, the complete disclosures of which are hereby incorporated by reference.

### BACKGROUND OF THE INVENTION

The invention is directed to a closure for multi-point locking of doors or wall parts in housings or cabinets by means of an actuating element such as a handle lever which can optionally be secured in a locking position, comprising a coupling element which is connected with the actuating element mounted in the door or wall so as to be rigid with respect to rotation relative to it and which transforms a rotational movement into a substantially translational movement and which is coupled with a rod that is mounted near the edge of the door or wall so as to be displaceable, one or more locking elements being coupled with the rod by a coupling element, respectively, in such a way that they move from a locked position into an unlocked position (or vice versa) by means of the displacement of the rod from a first position into a second position, and the locking elements and the coupling elements are formed in each instance by a two-armed, one-piece lever, one of whose lever arms is a locking tongue and whose other lever arm is articulated by its end at the rod.

### DESCRIPTION OF THE RELATED ART

In a closure of the type mentioned above which is already known from WO 2005/057312 A2, the rotational movement meshes a toothed rack with a plurality of pinions, one of which is connected to an actuating element so as to be rigid with respect to rotation relative to it, namely, to a swivel lever which can be locked in the swiveled-in position. The other pinions or toothed wheels have fastening elements which can be inserted into recesses arranged at a distance of 90 degrees.

Further, a closure in which a rod is displaceable substantially parallel to the door edge by means of one-armed lever devices at the edge of the door is known to the inventors. Similar to WO 2005/057312 A2, fastener tongues can be placed on the area of the rotary bearing support of the one-armed lever in four different positions which are provided at a distance of 90 angular degrees. One lever has no fastener tongues but, rather, is connected to a driveshaft of a rotary swivel lever drive.

DE 199 46 773 C2 discloses a closure for multi-point locking of a switch cabinet door in which a pinion drives two oppositely running rods at whose ends a lever arm of a closing lever is articulated, this lever arm being provided with a run-up slope that engages behind a back-engagement surface formed by the door frame when the rods are displaced in the closing direction. Accordingly, in this instance the double-lever which is shaped in one piece takes over the function of the closing tongue on the one hand and the function of the coupling and movement-transforming translation into rotation between the closing tongue and rod on the other hand. In particular, one lever arm is a locking tongue, while the other lever arm is articulated by its end to the rod and accordingly forms a driver. Therefore, the locking tongue is driven directly by the rod when the closure is actuated.

### SUMMARY AND OBJECT OF THE INVENTION

It is the primary object of the invention to make the known designs simpler and less expensive and to provide a simple and economical drive for multi-point closures with closing tongues.

The above object is met according to the invention in that at least one of the plurality of two-armed levers is connected to the driveshaft of an operating element so as to be rigid against rotation relative to it, and in that its two lever arms enclose an angle of 120 to 150 angular degrees, preferably approximately 135 (or 225) angular degrees. This results in a central drive of a plurality of movable locking elements by means of a connecting rod, wherein the driving bolt displacing the connecting rod is formed by a locking element of the kind mentioned above, which leads to a particularly simple closure construction.

This results in a direct drive between the operating element and the two-armed lever.

For reasons relating to kinematics, it is advantageous according to one aspect of the invention when the two-armed lever is rotatably mounted at the intersection point of the axes of the two lever arms at the door or wall or at a carrier, such as a stiffening profile, which is held at one of the latter.

According to another embodiment form of the invention, the last double-lever of a rod has another articulation possibility for another driver rod which is displaceable in the same direction or in a different direction, particularly perpendicular to the rod driving the double-lever. Therefore, more than one edge can be locked at the door.

According to yet another embodiment form of the invention, a double-lever is articulated at these additional rods.

The double-lever can have a third lever which is arranged so as to be offset by 180 degrees to the other lever and drives another rod.

The articulation can be carried out by means of a pin/hole system or by a screw connection or by a rivet connection.

The bearing support of the double-lever can be carried out by means of a sleeve terminating in an offset and annular shoulder, and the diameter and height of the offset is selected in such a way that the double-lever is held on the offset so as to be rotatable with slight play.

The sleeve can have a threaded bore hole for receiving a threaded bolt proceeding from the fastening surface and can have a head screw.

The threaded sleeve can advisably have an at least partially prismatic cross section such as a laterally flattened cross section or a hexagon. Therefore, the sleeve can be screwed onto an existing stud bolt or the like in a simple manner.

Alternatively, the threaded bolt can also be pressed into or welded in the door leaf, which is made of sheet metal, or can be screwed, preferably using a seal, into the door leaf which could then be made of any material.

Alternatively, the sleeve is a through-sleeve through which a head screw is guided, this head screw being screwed into a nut such as a press-in nut, a weld-on nut or standard nut, or into a threaded passage through a double-wall or an angle or frame.

A washer can advisably be arranged between the screw head and lever.

According to another alternative, the sleeve can be a through-sleeve through which a threaded bolt is guided, this threaded bolt being pressed in, welded or screwed, possibly with a seal, to the fastening surface, wherein the double-lever is held by a nut which is screwed to the bolt, such as a stop nut, possibly with the intermediary of a washer.

According to another embodiment form, the double-lever can have in its bearing area a recess/projection for receiving a driver or a driving square in a positive engagement, this driver or driving square forming a part of a lock drive or being driven by its spindle or its shaft.

The lock drive can comprise a closure lever which can be folded into a trough and optionally locked in the folded-in position.

### BRIEF DESCRIPTION OF THE DRAWINGS

The invention will be explained more fully in the following with reference to embodiment examples shown in the drawings.

FIG. 1 schematically shows a closure according to the invention for multi-point locking of a door in a door frame;

FIG. 2 is also a schematic view showing the operating principle of the arrangement according to the invention;

FIG. 3 is a longitudinal sectional view showing a first possibility for supporting the double-lever;

FIG. 4 shows a possible alternative bearing support in a view similar to that shown in FIG. 3;

FIG. 5 shows another possibility for supporting the double-lever, also in a longitudinal sectional view;

FIG. 6A is a perspective partial view showing the corner area (working area) of a door leaf with a closure device according to the invention arranged therein;

FIG. 6B is an exploded view of the closure from FIG. 6A;

FIG. 7A is a perspective view showing the working area of a door leaf provided with a closure device according to the invention;

FIG. 7B is an exploded view showing the working area of the closure according to the invention;

FIG. 8A is a top view of a door leaf provided with an open multi-point locking according to the invention;

FIG. 8B is a sectional view along section line A-A of FIG. 8A;

FIG. 8C is a cross-sectional view through the lower right-hand corner of the arrangement according to FIG. 8A or FIG. 8B;

FIG. 8D shows a section along section line B-B of FIG. 8A;

FIG. 8E shows the lower right-hand corner of the door with the closure according to the invention from FIG. 8A shown in the unlocked position;

FIG. 9A shows a view similar to that shown in FIG. 8A of a door outfitted with the closure according to the invention, the closure being shown here in the locked position;

FIG. 9B shows a section along line A-A from FIG. 9A;

FIG. 9C shows a section through the lower right-hand corner of the door leaf according to FIG. 9A or FIG. 9B;

FIG. 9D is a sectional view along section line B-B from FIG. 9A; and

FIG. 9E is a view of the lower right-hand corner of the door according to FIG. 9A showing the two-armed lever in the closed position.

### DESCRIPTION OF THE PREFERRED EMBODIMENTS

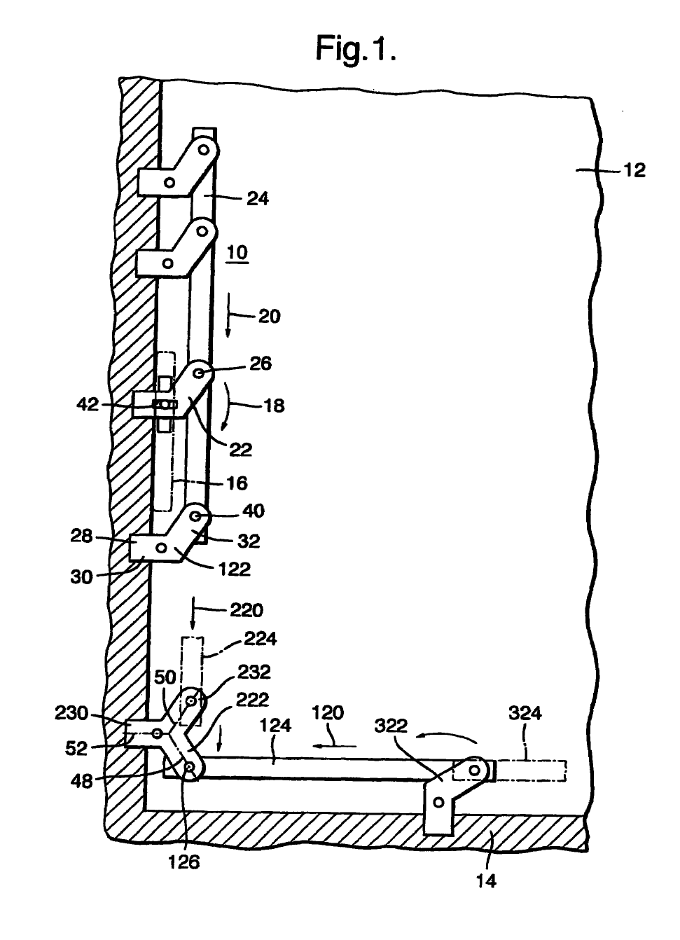

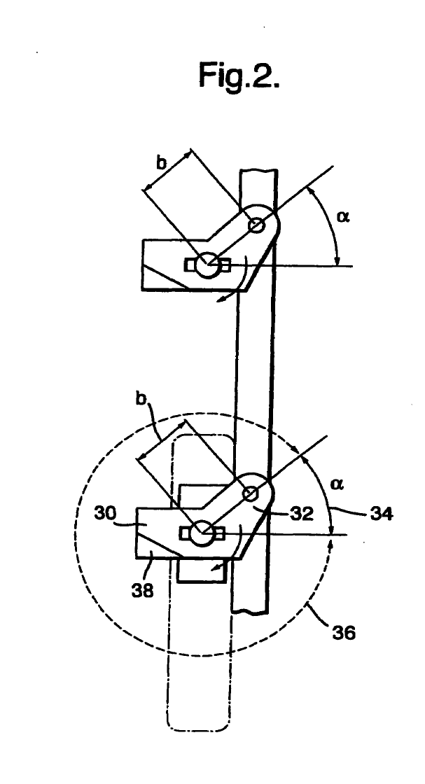

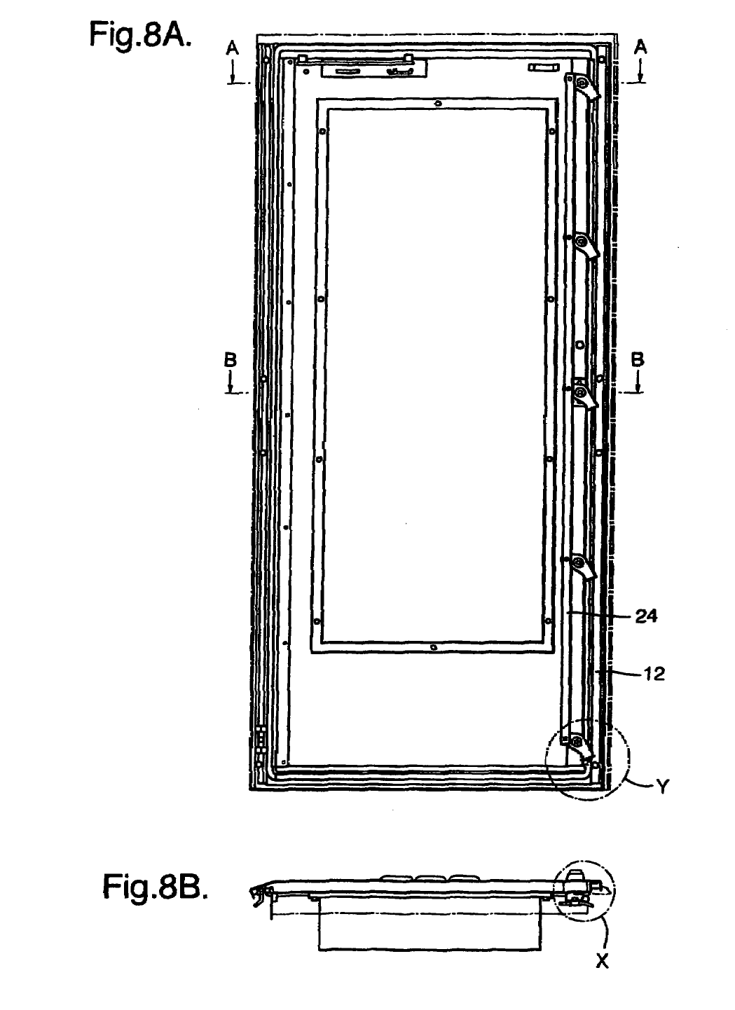

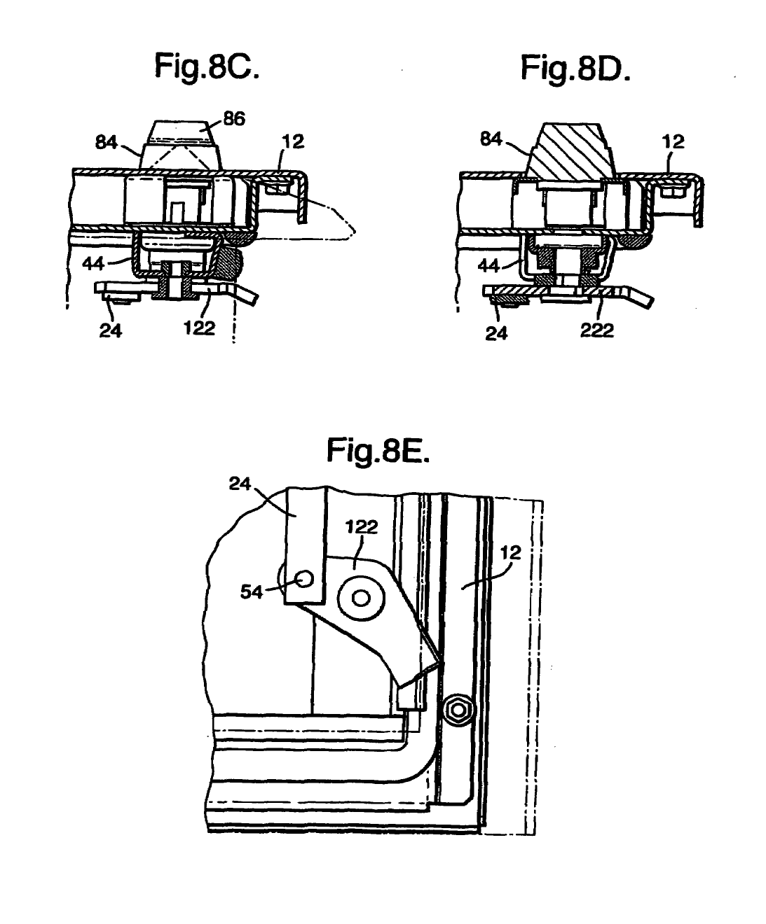

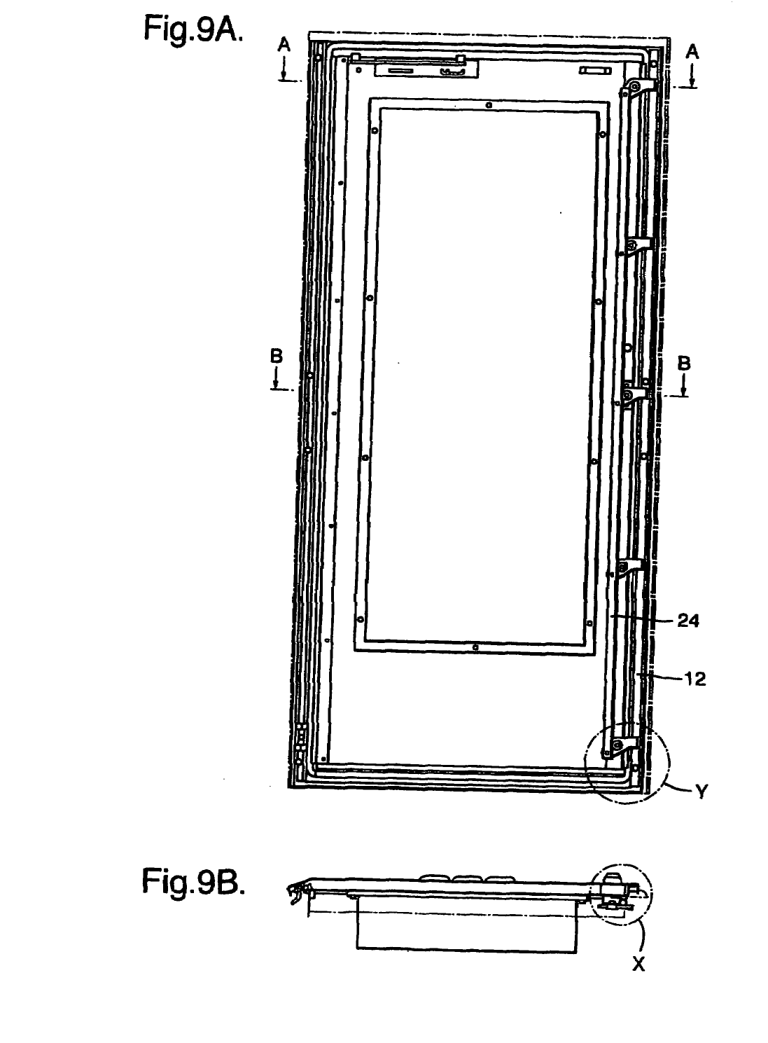

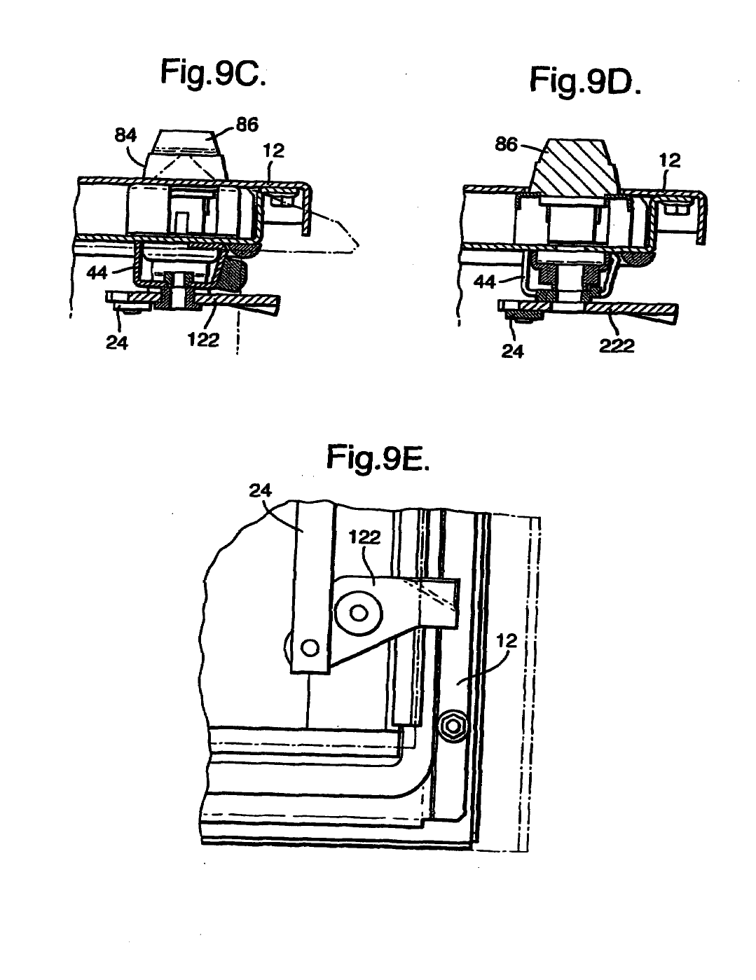

FIG. 1 schematically shows a closure 10 for the multi-point locking of a door or a wall part 12 in a housing or cabinet 14 by means of a preferably securable actuating element such as a handle lever 16 comprising a coupling element 22 which is connected to the actuating element 16 mounted in the door or wall 12 so as to be rigid with respect to rotation relative to it and which transforms a rotational movement 18 into a substantially translational movement 20 and which is coupled with a rod 24 that is mounted near the edge of the door or wall 12 so as to be displaceable, one or more locking elements 28 being coupled with the rod 24 by a coupling element 22, respectively, in such a way that they move from a locked position into an unlocked position (or vice versa) by means of the displacement of the rod 24 from a first position—see FIG. 8E—into a second position—see FIG. 1 or FIG. 9E. The locking elements 28 and the coupling elements 22 are formed in each instance by a two-armed, one-piece lever 22, whose two lever arms 30, 32 enclose an angle of approximately 135 and 225 angular degrees, respectively (reference numbers 34 and 38).

As can be seen from the drawings, one lever arm 30 is a locking tongue with a run-up slope 38. The other lever arm 32 is articulated by its end 34 at the rod 24.

At least one of the two-armed levers 22, 122, 222 is connected to the driveshaft 42 of an actuating element 16 so as to be rigid with respect to rotation relative to it.

In this case, the shaft 42 takes over the bearing support of the two-armed lever which is otherwise rotatably mounted at the intersection point of the longitudinal axes 50, 52 of the two lever arms at the door or wall 12 or at a carrier 44 (see FIG. 4), such as a stiffening profile, which is held at this door or wall 12.

The last double-lever 122 of a rod can have an articulation possibility for another driver rod 124 which is displaceable in the same direction 124 or in a different direction 224, particularly perpendicular to the rod 224 driving the double-lever 222 (see arrows 20, 120, 220). Double-levers 322 can likewise be articulated at the other rod 120.

According to FIG. 1, the double-lever 222 can have a third lever arm 46 whose axis 48 is arranged so as to be offset, e.g., by 90 or 120 degrees to the axis 50 of the other articulated lever 132 and drives another rod 124.

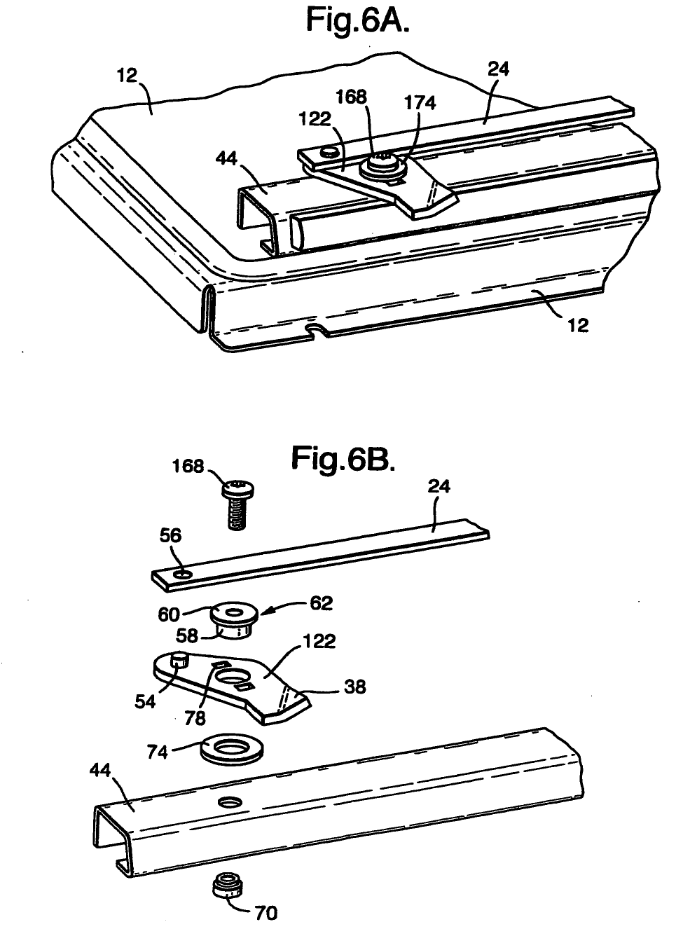

As is shown by FIG. 6A, the articulation between a rod 24 and the double-armed lever 122 can be carried out by means of a pin/hole system (see reference numbers 54, 56). Alternatively, the articulation can be carried out by a screw connection or by a rivet connection, which offers corresponding rotating possibilities.

The bearing support of the double-lever 122 can be carried out, e.g., by means of a sleeve 62 terminating in an offset 58 and annular shoulder 60. The diameter and height of the offset 58 is selected in such a way that the double-lever 122 is held on the offset 58 so as to be rotatable with slight play.

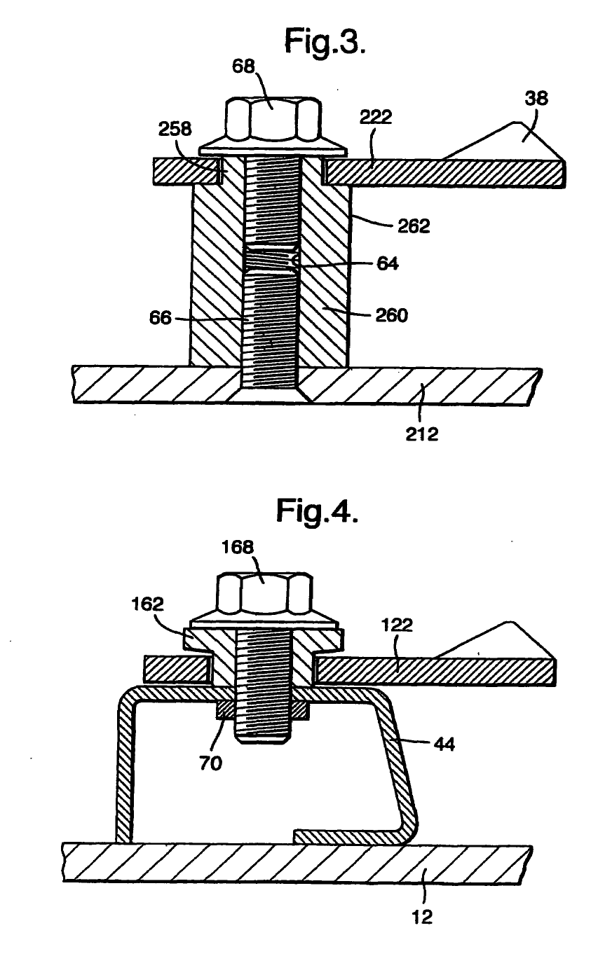

According to FIG. 3, the sleeve 262 has a threaded bore hole 64 for receiving a threaded bolt 66 proceeding from the fastening surface 212 and can have a head screw 68.

In the embodiment form shown in FIG. 3, the head of the screw 68 projects over the offset 258 in such a way that the double-lever 222 cannot slip off from the threaded sleeve 262.

The threaded bolt 68 can be pressed into or welded in the door leaf 212, which is made of sheet metal, or can be screwed, preferably using a seal, into the door leaf 212 which could then be made of any material, e.g., plastic.

It is easier to screw on the threaded sleeve 262 when this threaded sleeve 262 has an at least partially prismatic cross section, e.g., is laterally flattened or is constructed as a hexagon.

As is shown in FIG. 4, the sleeve 162 can also be a through-sleeve through which a head screw 168 is guided, this head screw 168 being screwed into a nut 70 such as a press-in nut, a weld-on nut or standard nut, or into a threaded passage through a double-wall 44, or an angle or frame.

A washer (not shown in FIG. 3) can be arranged between the screw head of the head screw 68 and the lever or locking tongue 22.

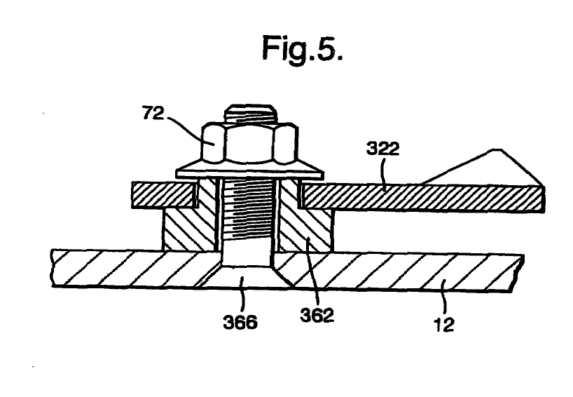

In another variant shown in FIG. 5, a sleeve 362 is constructed as a through-sleeve through which a threaded bolt 366 is guided, this threaded bolt 366 being pressed in, welded or screwed, possibly with a seal, to the fastening surface 12, The double-lever or locking tongue 322 is held by a nut which is screwed to the bolt 366, such as a stop nut, possibly with the intermediary of a washer (see reference number 74 in FIG. 6B).

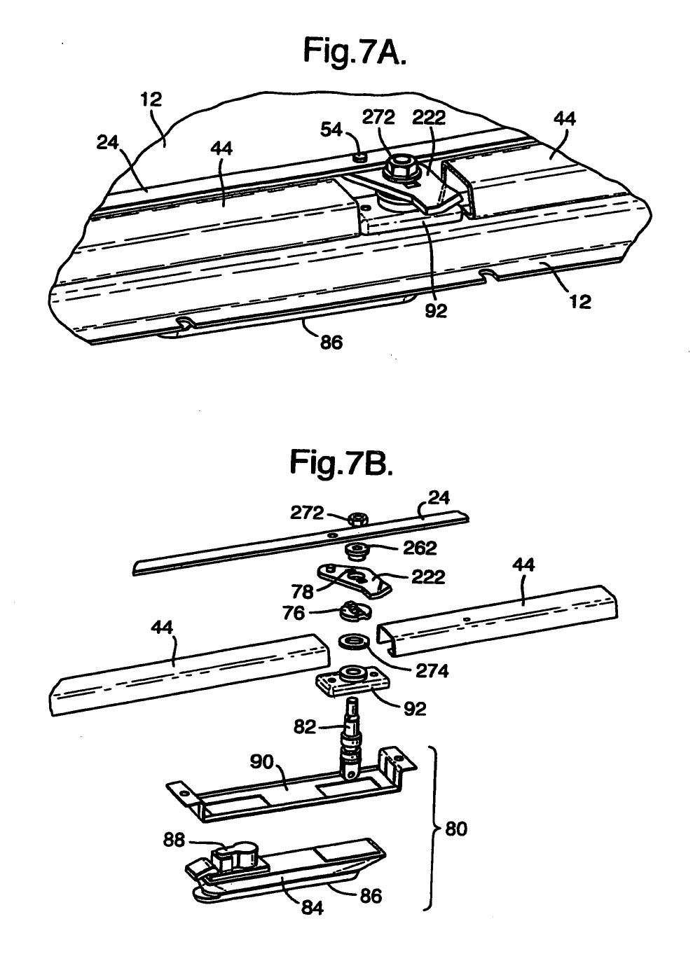

FIG. 7A shows a closure in which the double-lever 222 has in its bearing area a recess/projection 78 for receiving a driver 176 or driving square in a positive engagement, this driver or driving square being a part of a lock drive 80 or being driven by its spindle or its shaft 82.

According to FIG. 7B, the lock drive 80 comprises a closure lever 86 which can be folded into a trough 84 and which is articulated at the end of the shaft 82 and can optionally be locked with a cylinder lock (see reference number 88) in the folded-in position as is shown in FIG. 7B.

The trough 84 is held on a closure housing 90, the articulating spindle 82 being supported, e.g., in a lock case 92.

While FIG. 6A shows a double-lever 122 that is driven by the rod 24, the double-lever 222 shown in FIG. 7A is driven by the actuating means 86 and even drives the rod 24. In FIG. 6A, the double-lever 122 is supported by the profile 44, while in FIG. 7A a discontinuity is provided in the profile and the double-lever 22 is supported by the actuation means.

### COMMERCIAL APPLICABILITY

The invention is commercially applicable in switch cabinet construction.

While the foregoing description and drawings represent the present invention, it will be obvious to those skilled in the art that various changes may be made therein without departing from the true spirit and scope of the present invention.

### REFERENCE NUMBERS

10 closure
12, 212 door, wall part
14 cabinet, housing
16 handle lever, actuating element
18 rotational movement
20, 120, 220 translational movement
22, 122, 222, 322 coupling element, lever
24, 124, 224, 324 rod
26, 126 coupling, articulation
28 locking element
30, 230 lever arm
32, 232 lever arm
34 135-degree angle
36 225-degree angle
38 run-up slope
40 end
42 driveshaft
44 carrier, stiffening profile
46 third lever arm
48 axis
50 axis
52 axis
54 pin
56 hole
58, 258 offset
60, 260 annular shoulder
62, 162, 262, 362 sleeve
64 threaded bore hole
66, 366 threaded bolt
68, 168 head screw
70 nut, threaded passage
72, 172 stop nut
74, 174, 274 washer
76 driver
78 recess/projection
80 lock drive
82 spindle, shaft
84 trough
86 closure lever
88 locking means
90 closure housing
92 lock case

What is claimed is:

1-17. (canceled)

18. A closure for multi-point locking of doors or wall parts in housings or cabinets by a securable actuating element such as a handle lever, comprising:
a coupling element which is connected with the actuating element mounted in the door or wall so as to be rigid against rotation relative to it and which transforms a rotational movement into a substantially translational movement and which is coupled with a rod that is mounted near the edge of the door or wall so as to be displaceable;
one or more locking elements being coupled with the rod by a coupling element, respectively, in such a way that they move from a locked position into an unlocked position (or vice versa) by means of the displacement of the rod from a first position into a second position;
said locking elements and said coupling elements being formed in each instance by a two-armed, one-piece lever, one of whose lever arms being a locking tongue and whose other lever arm being articulated by its end at the rod;
at least one of the two-armed levers being connected to the driveshaft of an actuating element so as to be rigid against rotation relative to it;
said two-armed lever being rotatably mounted at the intersection point of the axes of the two lever arms at the door or wall or at a carrier, such as a stiffening profile, which is held at one of the latter; and
said double-lever having in its bearing area a recess/projection for receiving a driver or driving square in a positive engagement, said driver or driving square being a part of a lock drive or being driven by its spindle or shaft.

19. The closure according to claim 18, wherein a double-lever of a rod has another articulation possibility for another driver rod which is displaceable in the same direction or in a different direction, particularly perpendicular to the rod driving the double-lever.

20. The closure according to claim 19, wherein double-levers are likewise articulated at the additional rod.

21. The closure according to claim 18, wherein the double-lever has a third lever arm whose axis is arranged so as to be offset to the axes of the other lever arms and drives another rod.

22. The closure according to claim 18, wherein the articulation is carried out by a pin/hole system, by a screw connection or by a rivet connection.

23. The closure according to claim 18, wherein the bearing support of the double-lever is carried out by a sleeve terminating in an offset and annular shoulder, wherein the diameter and height of the offset is selected in such a way that the double-lever is held on the offset so as to be rotatable with slight play.

24. The closure according to claim 23, wherein the sleeve has a threaded bore hole for receiving a threaded bolt proceeding from the fastening surface and has a head screw.

25. The closure according to claim 24, wherein the threaded sleeve has an at least partially prismatic cross section such as a laterally flattened or hexagonal shape.

26. The closure according to claim 23, wherein the threaded bolt is pressed into or welded in the door leaf, which is made of sheet metal, or is screwed, preferably using a seal, into the door leaf which is then made of any material such as plastic.

27. The closure according to claim 23, wherein the sleeve is a through-sleeve through which a head screw is guided, this head screw being screwed into a nut such as a press-in nut, a weld-on nut or standard nut, or into a threaded passage in a double-wall or an angle or frame.

28. The closure according to claim 23, wherein a washer is arranged between the screw head and the lever.

29. The closure according to claim 23, wherein the sleeve is a through-sleeve through which a threaded bolt is guided, this threaded bolt being pressed in, welded or screwed, possibly with a seal, to the fastening surface, wherein the double-lever is held by a nut which is screwed to the bolt, such as a stop nut, possibly with the intermediary of a washer.

30. The closure according to claim 18, wherein the lock drive comprises a closure lever which can be folded into a trough and which can optionally be locked in the folded-in position.

31. The closure according to claim 30, wherein the closure lever is articulated at the end of the shaft.

32. The closure according to claim 30, wherein the trough is held on a closure housing.

33. The closure according to claim 32, wherein the articulated spindle is mounted in a lock case.

34. The closure according to claim 18, wherein the double lever is supported by the actuating means in a discontinuity in the profile.
